(19) United States
(12) Patent Application Publication
(10) Pub. No.: US 2026/0253190 A1
(43) Pub. Date: Aug. 27, 2026

(54) LEARNING BASED ASSESSMENT OF MULTI-SHOT VIDEO CLIP ASSEMBLIES

(71) Applicant: Adobe Inc., San Jose, CA (US)

(72) Inventors: Md mehrab Tanjim, Santa Clara, CA (US); Somdeb Sarkhel, San Jose, CA (US); Saayan Mitra, San Jose, CA (US); Ishita Dasgupta, South San Francisco, CA (US); Gang Wu, San Jose, CA (US); Chen-yi Lu, West Lafayett, IN (US)

(73) Assignee: Adobe Inc., San Jose, CA (US)

(21) Appl. No.: 19/060,506

(22) Filed: Feb. 21, 2025

(51) Int. Cl. G06T 7/00; G06N 3/0455; G06N 3/08; G06V 10/74; G06V 10/774; G06V 10/82; G06V 20/40; G11B 27/031

(52) U.S. Cl. CPC G06T 7/0002; G06N 3/0455; G06N 3/08; G06V 10/761; G06V 10/774; G06V 20/48; G11B 27/031; G06T 2200/24; G06T 2207/10016; G06T 2207/20081; G06T 2207/20084; G06T 2207/30168; G06V 10/82

(57) ABSTRACT

Techniques for learning based assessment of clip assemblies for multi-shot videos are described. In an example, a processing device is operable to receive a plurality of single-shot video clips and generate embeddings of each of the single-shot video clips using a machine learning model. The processing device is further operable to transform the embeddings into a video representation using the machine learning model and determine a learned quality score of a multi-shot video sequence assembled from the single-shot video clips by processing the video representation through a regression layer of the machine learning model. The processing device is configurable to output the learned quality score as a measure of assembly quality for the multi-shot video sequence.

### BACKGROUND

Video content creation is increasing in popularity with the prevalence of video publishing and video sharing platforms. Creating engaging multi-shot videos generally involves assembling multiple single-shot video clips into a coherent sequence. Selecting appropriate clips and arranging the clips in a logical and visually appealing manner is a time-consuming and tedious task. Professional and novice users of conventional systems for video assembly often struggle to effectively assess the coherence and semantic flow between scenes in multi-shot videos. Existing approaches do not adequately capture nuances of human preferences in video composition, potentially leading to low-quality videos when automatically assembling clips or providing guidance to users during video authoring processes.

### SUMMARY

Learning based assessment of clip assemblies for multi-shot videos is described to address conventional technical challenges assembling video clips into high-quality coherent multi-shot videos. A system (e.g., a content processing system) configured to assess multi-shot video assembly quality is provided that utilizes a transformer based video encoder to process image and position embeddings of single-shot video clips and generate a representative feature vector. The system includes at least one machine learning model that is trained based on a two-stage training framework, including a contrastive pre-training stage to learn meaningful feature representations (e.g., a video representation), followed by a regression stage to align the feature representations with user preferences. Training the machine learning model in multiple stages enables effective utilization of unlabeled videos to avoid having to collect user feedback like with conventional systems. The system generates a learned quality score (also referred to as a Learned Clip Assembly or LCA score) as an objective metric for quantifying multi-shot video assembly quality. The learned quality score is generated using a regression model trained on the learned feature representations. The learned quality score indicates a measure of coherence and semantic flow between scenes (e.g., between single-shot clips) that are assembled in multi-shot video sequences, providing an objective evaluation of whether the video assembly aligns with user preferences, generally. By focusing on assembly quality rather than pure technical or aesthetic aspects, the system outputs a comprehensive assessment of multi-shot videos, enabling both amateur and professional users to have confidence creating engaging and coherent video content.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF FIGURES

The detailed description is described with reference to the accompanying figures. Entities represented in the figures are indicative of one or more entities and thus reference is made interchangeably to single or plural forms of the entities in the discussion.

FIG. 1 illustrates a block diagram of an environment of a content generation system in an example implementation that is operable to employ techniques described herein for learning based assessment of clip assemblies for multi-shot videos.

FIG. 2 illustrates a block diagram of a learning system trained to assess multi-shot video clip assemblies, according to the described techniques herein.

FIG. 3 illustrates a block diagram of a contrastive training system for training a transformer based video encoder of the learning system shown in FIG. 2.

FIG. 4 illustrates a block diagram of a supervised training system for training a regression model of the learning system shown in FIG. 2.

FIG. 5 shows a flow diagram depicting an algorithm as a step-by-step process, which is performable by a processing device for training a learning system to implement learning based assessment of clip assemblies for multi-shot videos.

FIG. 6 shows a flow diagram depicting an algorithm as a step-by-step process, which is performable by a processing device for implementing a pre-trained learning system to implement learning based assessment of clip assemblies for multi-shot videos.

FIG. 7 shows a flow diagram depicting an algorithm as a step-by-step process, which is performable by a processing device when executing a training module for training a learning system to implement learning based assessment of clip assemblies for multi-shot videos.

FIG. 8 illustrates an example system including various components of an example device usable as any type of computing device as described and/or utilized with reference to FIGS. 1-7 to implement examples of the techniques described herein.

### DETAILED DESCRIPTION

### Overview

Creating engaging multi-shot videos typically involves assembling multiple single-shot video clips into a coherent sequence. Each single-shot video clip represents a continuous video segment captured in a single take (e.g., unedited), possibly ranging from a few seconds (e.g., 2 to 10 seconds) to a few minutes in duration. The single-shot video clips are assembled into a multi-shot video that represents a coherent video narrative. Clip assembly involves selecting, arranging, and combining the single-shot video clips in a logical manner to produce a visually appealing composition. Conventional video quality assessment systems focus primarily on technical and aesthetic aspects of individual shots, and struggle to effectively evaluate whether multi-shot video assemblies achieve coherence and semantic flow between scenes.

Existing approaches to video quality assessment, such Deep Objective Video Evaluation Representation (DOVER) and Q-Align, primarily evaluate technical aspects including blurriness, brightness, contrast, overexposure, and aesthetic qualities based on user preferences. Q-Align is an example a video quality assessment technique, which aligns video quality with human perception by learning from subjective ratings collected from users. Q-Align utilizes a deep neural network to extract features from video frames and predict quality scores, however, the scores are deficient in assessing coherence and semantic flow between scenes. In addition, collecting extensive user feedback is costly and limits scalability. DOVER is another example of a video quality assessment framework that uses deep learning to evaluate both technical and perceptual aspects of video quality. DOVER predicts various quality-related attributes, however, like Q-Align, DOVER does not evaluate assembly quality or overall coherence of video sequences assembled from multiple clips. A video assembled from a random sequence of high-quality single-shot clips is capable of receiving a high-quality score when using DOVER, Q-Align, or other conventional video assessment techniques, even though the random nature of the video assembly lacks overall coherence and semantic flow.

To address these challenges, a system for assessing multi-shot video assembly quality is described that utilizes a transformer based video encoder to process embeddings of video shots and generate a video representation, such as a representative feature vector. The system is configurable to employ a two-stage training framework, including a contrastive pre-training stage to learn meaningful feature representations followed by a regression stage to align the feature representations with human preferences, overall.

The system introduces a Learned Clip Assembly (LCA) score as a quantifiable metric for measuring multi-shot video assembly quality. For example, the LCA score is generated using a lightweight regression model (e.g., one or more regression layers of a neural network) trained on the learned feature representations. The LCA score specifically assess the coherence and semantic flow between scenes in a multi-shot video assembly to quantify quality, and provide an objective evaluation of the video assembly, which generally aligns with human preferences.

The system initiates a first-stage of a two-stage training process by generating positive multi-shot video sequences (e.g., by applying frame-level augmentations to reference videos) and negative sequences (e.g., by replacing shots with dissimilar, unrelated clips). The first training stage is effective at training the system to process unlabeled data, which alleviates conventional collection of costly user feedback. The system is configurable to utilize a transformer based video encoder that processes embeddings of multi-shot videos to generate a representative feature vector. The embeddings are vector representations of video frames generated by a vision encoder, such as a Contrastive Language-Image Pre-training (CLIP) model, which captures visual features in a format to be processed by a transformer based video encoder. The transformer based video encoder includes a neural network that processes the embeddings using self-attention to capture temporal and spatial relationships between video frames and individual video shots. The transformer based video encoder is trained in the first training stage using contrastive learning based on positive and negative pairs of the generated video sequences. Positive pairs are constructed, for instance, using shots from the same reference video with random frame-level augmentations, such as adjustments to brightness, contrast, or geometric transformations, while negative pairs consist of videos with replaced shots. Training the neural network through contrastive learning configures the neural network to evaluate similarity across multiple shots by learning to distinguish between the positive training examples assembled with similar shots, and the negative training examples assembled with one or more dissimilar shots.

To generate the LCA score, the system employs a regression model that processes the learned representations from the video encoder. The regression model is trained during the second training stage based on training data that includes a set of multi-shot videos with corresponding user feedback scores collected prior, and uses a loss function to output learned quality scores that align with human preferences that are normalized by the training example user feedback scores. The LCA score effectively captures the nuances of video assembly quality, achieving strong correlation between user preferences for multi-shot videos, generally. Both amateur and professional users are able to create more engaging and coherent video content with the system by refining video creations until the LCA score satisfies an objective quality threshold for assessing multi-shot video clip assemblies. The system is configured to effectively evaluate and quantify video coherence automatically, without relying on costly collection of user feedback.

By focusing on assembly quality rather than purely technical or aesthetic aspects, the system offers a more comprehensive assessment of multi-shot videos than conventional video assessment systems. In addition, the described machine learning architecture addresses other challenges of conventional approaches by providing a robust, scalable solution. Furthermore, the system introduces capability to process diverse, real-world single-shot video clip inputs, which allows for more flexible and realistic assessment of video assemblies, overcoming the constraints of conventional systems that define strictly controlled input criteria.

Further discussion of these and other examples and advantages are included in the following sections and shown using corresponding figures. In the following discussion, an example environment is described that employs the techniques described herein. Example processes are also described that are performable in the example environment as well as other environments. Consequently, performance of the example processes is not limited to the example environment and the example environment is not limited to performance of the example processes.

### Example Environment for Assessing Clip Assembly Coherency

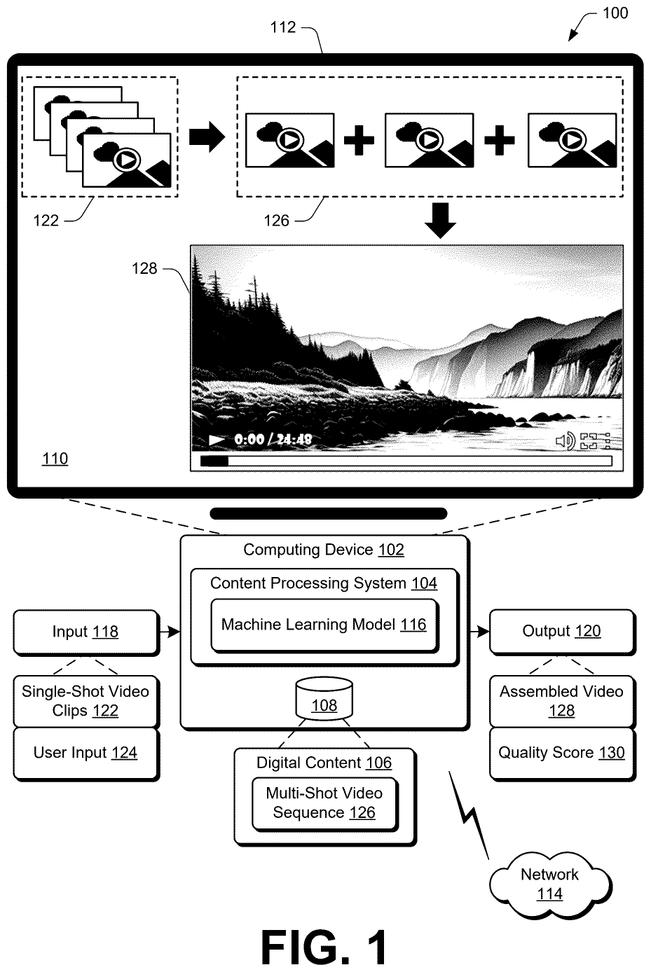

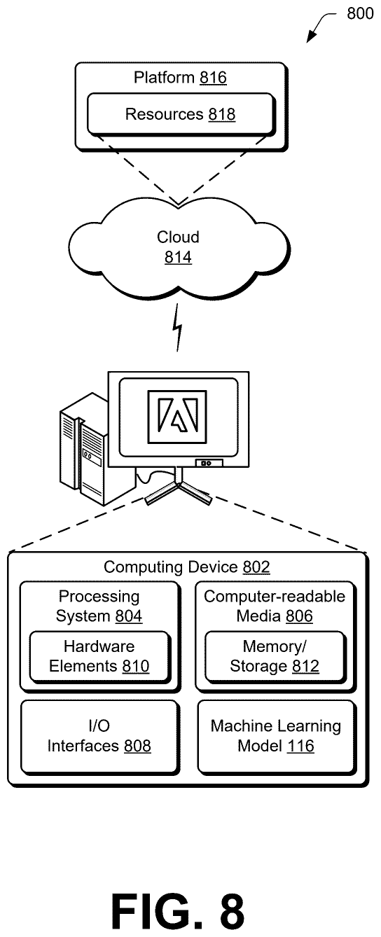

FIG. 1 illustrates an environment 100 for assessing and assembling multi-shot videos. The environment 100 includes a computing device 102, which is configurable in a variety of ways. The computing device 102, for instance, is configurable as a processing device such as a desktop computer, a laptop computer, a mobile device (e.g., assuming a handheld configuration such as a tablet or mobile phone), and so forth. Thus, the computing device 102 ranges from full resource devices with substantial memory components and processor resources (e.g., personal computers, game consoles) to a low-resource device with limited memory and/or processing resources, e.g., mobile devices. Additionally, although a single computing device 102 is shown, the computing device 102 is also representative of a plurality of different devices (e.g., a computing system), such as multiple servers utilized by a business to perform operations “over the cloud” as described in FIG. 8.

The computing device 102 is illustrated as including a content processing system 104. The content processing system 104 is implemented at least partially in hardware of the computing device 102 to process and transform digital content 106, which is illustrated as being maintained in a data storage 108 of the computing device 102. Such processing includes creation of the digital content 106, such as multi-shot video sequences and single-shot video clips. Other examples of such processing include modification of the digital content 106, and production of the digital content 106 for presentation in a user interface 110, e.g., for output by a display device 112.

The computing device 102 is depicted as being connected to a network 114, which enables communication with other devices or systems. The network 114 enables the computing device 102 to access additional resources or data to support functionality of the content processing system 104. Although illustrated as implemented locally at the computing device 102, functionality of the content processing system 104 is also configurable in whole or in part through functionality available via the network 114, such as part of a web service or “in the cloud”.

An example of functionality incorporated by the content processing system 104 for processing the digital content 106 is illustrated as a machine learning model 116, which is configured to handle complex data processing tasks by receiving input 118 and generating output 120. The machine learning model 116 is operable to analyze the input 118 to assess the coherence and quality of potential video assemblies. In some cases, the machine learning model 116 is trained to recognize patterns and relationships between different video clips to determine improved combinations. The machine learning model 116 enables the content processing system 104 to assess and improve the quality of multi-shot video assemblies, addressing the challenges faced by both amateur and professional users in creating engaging and coherent video content.

The input 118 to the machine learning model 116 is depicted as a plurality of single-shot video clips 122 and user input 124. The single-shot video clips 122 are continuous video segments captured without cuts or edits, for example, ranging from a few seconds to a few minutes in duration. The single-shot video clips 122 represent combinable video segments to form a multi-shot video sequence 126. For example, each of the single-shot video clips 122 depicts a single cohesive scene that is less than one minute in duration. The user input 124 includes various information input to the user interface 110 by a user, such as preferences, instructions, or other information provided to guide a video assembly process performed using the machine learning model 116. The output 120 generated by the machine learning model 116 includes an assembled video 128 and a quality score 130. The assembled video 128 is an example of the multi-shot video sequence 126, created by the machine learning model 116 from combining one or more of the single-shot video clips 122. The assembled video 128 assembles one or more of the single-shot video clips 122 together to form a coherent video narrative or composition. The quality score 130 provides an objective assessment of the coherence and overall quality of the assembled video 128.

The user interface 110 enables users to interact with the content processing system 104, view the assembled video 128, and receive feedback through the quality score 130. In some aspects, the user interface 110 presents the single-shot video clips 122 designated as input 118 alongside a visual representation of the multi-shot video sequence 126. Users are able to manipulate the multi-shot video sequence 126 using various controls, and the user input 124 instructs the content processing system 104 to generate the assembled video 128. In some cases, the user interface 110 includes playback functionality for the assembled video 128, allowing users to review the final composition. The user interface 110 is configurable to present the single-shot video clips 122 and multi-shot video sequence 126 for playback and receive user feedback quality scores through the user input 124, which are usable to further train the regression model 204.

In some cases, the multi-shot video sequence 126 is assembled from the single-shot video clips 122 based on the quality score 130. For example, when the quality score 130 satisfies a quality threshold, e.g., a lower bound in a range of score values corresponding to an acceptable quality level, the machine learning model 116 constructs the assembled video 128 to represent the multi-shot video sequence 126 as a series including a plurality of the single-shot video clips 122. When the quality threshold is not satisfied, the machine learning model 116 improves the multi-shot video sequence 126 by regenerating the multi-shot video sequence 126, automatically or based in part on commands interpreted from the user input 124, possibly multiple times to improve the quality score 130 towards satisfying the quality threshold. As depicted in FIG. 1, the multi-shot video sequence 126 is configured as the assembled video 128, which is output from the content processing system 104, such as for playback at the user interface 110.

The environment 100 offers a comprehensive solution for assessing and assembling multi-shot videos by leveraging the machine learning model 116 to process input 118 and produce high-quality video assemblies with corresponding quality assessments. The content processing system 104 accepts the single-shot video clips 122 and the user input 124, from which the machine learning model 116 processes this input to create an assembled video 128, combining two or more of the single-shot video clips 122 into a coherent narrative or composition. The content processing system 104 generates the quality score 130 to provide an objective assessment of the coherence and overall quality of the assembled video 128. The content processing system 104 overcomes challenges faced by both amateur and professional users in creating engaging and coherent video content by offering automated assistance in video assembly and objective quality evaluation. By utilizing the machine learning model 116, the content processing system 104 continuously assesses and enhances multi-shot video assemblies, tackling the complexities of selecting and arranging clips to form logically and visually appealing sequences.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Learning Based Clip Assembly Architecture

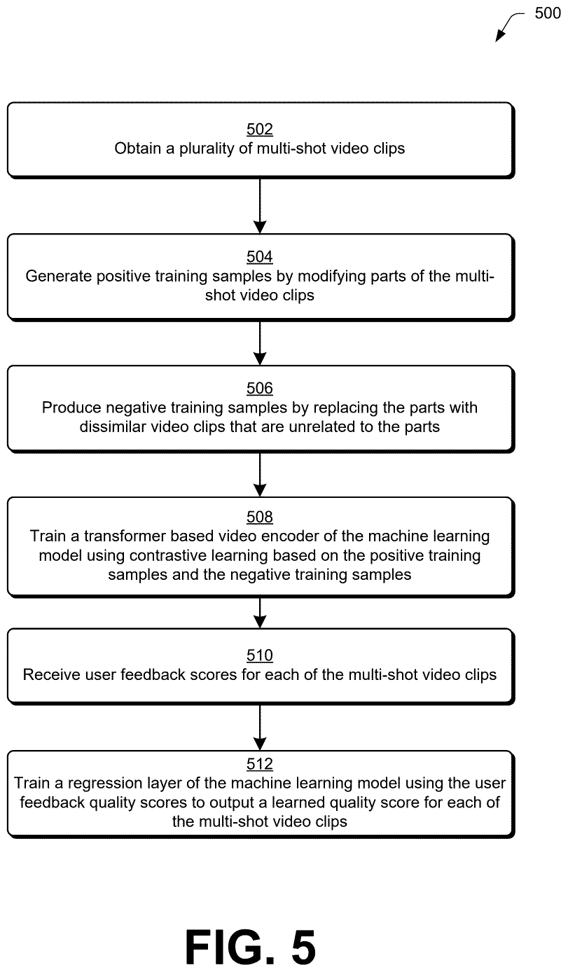

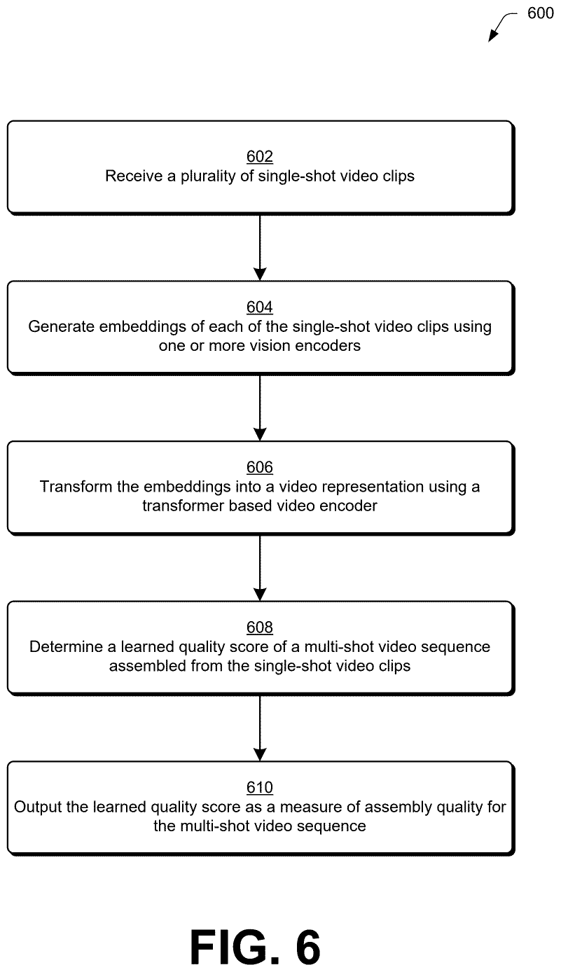

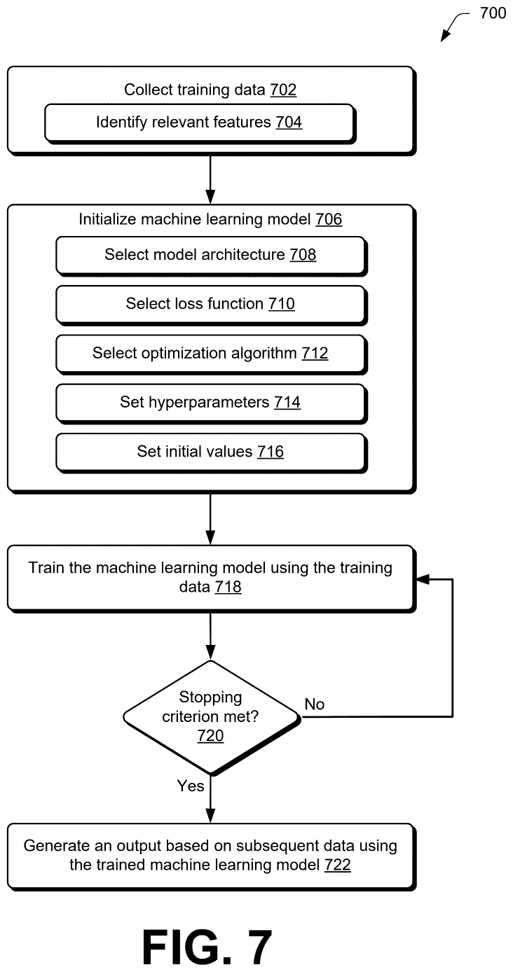

The following discussion describes techniques for learning based clip assembly of multi-shot videos, which are implementable utilizing the systems and devices described herein. Aspects of each of processes implemented by the systems and devices are implemented in hardware, firmware, software, or a combination thereof. The processes, e.g., as shown in FIG. 5, FIG. 6, and FIG. 7, depict a set of blocks that specify operations performed by one or more devices and are not limited to the orders shown for performing the operations by the respective blocks.

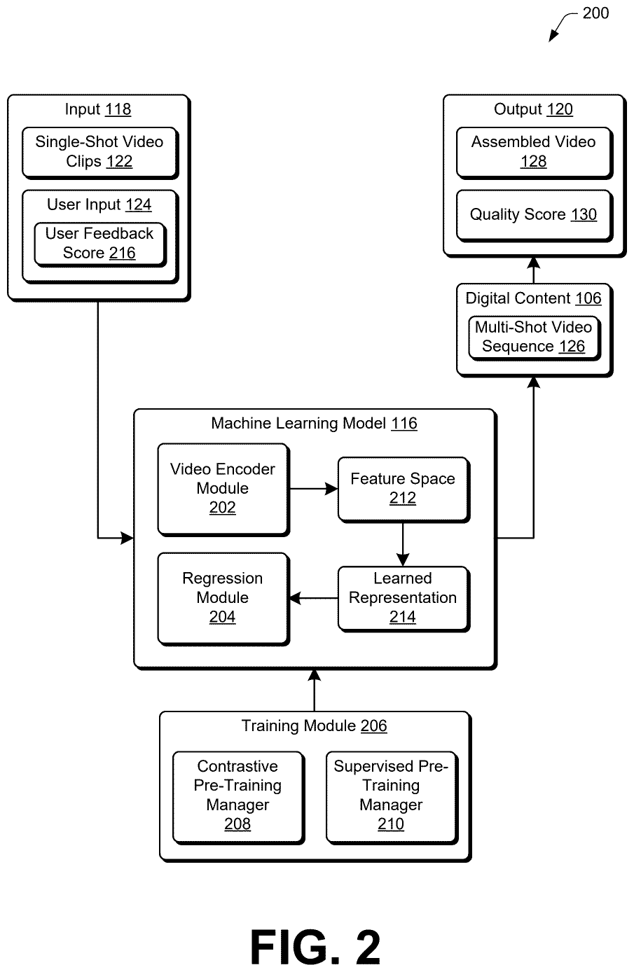

FIG. 2 illustrates a block diagram of a learning system 200 trained to assess multi-shot video clip assemblies, according to the described techniques herein. The learning system 200 is an example of at least part of the content processing system 104 depicted in FIG. 1.

The system 200 receive the input 118 including the single-shot video clips 122 and the user input 124, which in this example includes a user feedback score 216. The machine learning model 116 processes the input 118 using a video encoder module 202. The video encoder module 202 processes the input 118 and generates video representations in a feature space 212. The feature space 212 produces a learned representation 214 that feeds into a regression module 204. In some implementations, the feature space 212 includes different clusters corresponding to various types of video sequences or assembly qualities.

A training module 206 connects to the machine learning model 116 and includes two components: a contrastive pre-training manager 208 and a supervised pre-training manager 210. These components are operatively coupled to train the machine learning model 116. In some aspects, the contrastive pre-training manager 208 implements a self-supervised learning approach to help the machine learning model 116 learn to distinguish between coherent and incoherent video sequences without utilizing explicit human annotations.

In some aspects, the video encoder module 202 processes the single-shot video clips 122 to extract relevant features. The video encoder module 202 utilizes various techniques such as convolutional neural networks or transformer architectures to analyze the visual content of each clip. In some cases, the video encoder module 202 includes multiple vision encoders, each processing a different single-shot video clip.

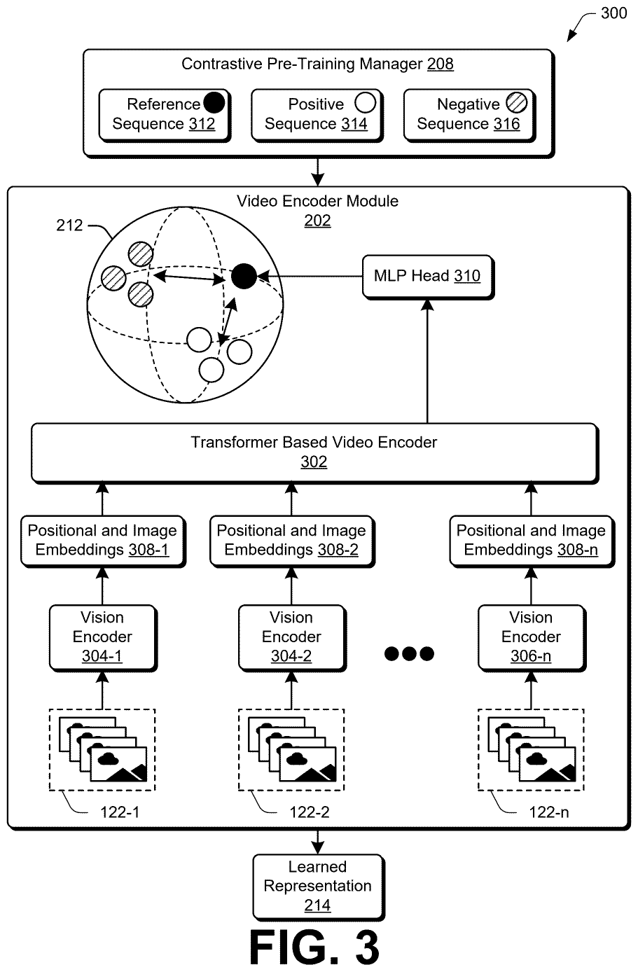

The feature space 212 generated by the video encoder module 202 represents a high-dimensional space where each point corresponds to a specific video clip or sequence. The learned representation 214 derived from this feature space capture prominent characteristics of the assembled video 128, such as temporal coherence and visual consistency between clips. In some implementations, the feature space 212 includes different clusters of learned representations, which are depicted in FIG. 3 as filled circles, empty circles, and patterned circles, each potentially corresponding to different types of video sequences or assembly qualities.

The regression module 204 receives the learned representation 214 as input and produces the quality score 130. In some cases, the regression module 204 is implemented as a neural network trained to map the learned representations to numerical scores that reflect the perceived quality of the video assembly. The regression module 204 includes a linear layer 402 that processes the learned representation 214 to generate a learned score 404. The learned score 404, along with the user feedback score 216, serves as input to a loss function 406, which guides the training process of the regression module 204. The regression module 204 includes a linear layer 402 that processes the learned representation 214 to generate a learned score 404. The learned score 404, along with the user feedback score 216, serve as inputs to a loss function 406, which guides the training process of the regression module 204.

The training module 206 oversees the learning process of the machine learning model 116. The contrastive pre-training manager 208 implements a self-supervised learning approach, where the machine learning model 116 learns to distinguish between coherent and incoherent video sequences without requiring explicit human annotations. The contrastive pre-training manager 208 is configurable to process three types of sequences: a reference sequence 312, a positive sequence 314, and a negative sequence 316. The positive sequence 314 is generated by applying frame-level augmentations to the reference sequence, while the negative sequence 316 is created by replacing clips with dissimilar content.

The supervised pre-training manager 210 is operable to fine-tune the machine learning model 116 using the user feedback score 216, aligning predictions of the machine learning model 116 with human judgments of video assembly quality. This two-stage training approach enables the system 200 to leverage large amounts of unlabeled data while still benefiting from targeted human feedback. The supervised pre-training manager 210 is able to oversee the fine-tuning process using human-annotated data, providing the learned representation 214 to the regression module 204 for further processing.

In operation, the system 200 receives the single-shot video clips 122 and user input 124 as the input 118. The machine learning model 116 processes the input 118 to generate the assembled video 128 and the corresponding quality score 130 as the output 120. The quality score 130 provides an objective metric of how well the individual clips have been assembled into a coherent multi-shot video sequence 126. The score is useable to guide users in creating more engaging and coherent multi-shot video sequences, potentially improving the overall quality of video content creation. The quality score 130 is further usable to guide users in creating more engaging and coherent multi-shot video sequences, potentially improving the overall quality of video content creation.

FIG. 3 illustrates a block diagram of a contrastive training system 300 for training a transformer based video encoder of the learning system 200. The contrastive training system 300 is an example of at least part of the content processing system 104 depicted in FIG. 1. The system 300 includes a video encoder module 202 that processes multiple single-shot video clips 122-1, 122-2, through 122-n. Each of the single-shot video clips 122-1, 122-2, through 122-n is processed by a vision encoder. For example, the system 300 includes a plurality of vision encoders 304, which are labeled individually as vision encoder 304-1, 304-2, through 306-n, and each represent pre-trained vision encoders configured to process the single-shot video clips 122-1, 122-2, through 122-n, respectively.

In some implementations, the vision encoders 304-1, 304-2, and 306-n are implemented as CLIP ViT/B-32 models. The vision encoders 304-1, 304-2, and 306-n, for instance, uniformly sample ten frames from the single-shot video clip 122-1, 122-2, and 122-n for encoding. The output of each of the vision encoders 304 is combined with positional and image embeddings 308-1, 308-2, through 308-n. For example, the vision encoders 304 configure the transformer based video encoder 302 to combine image type embeddings and positional type embeddings of each of the single-shot video clips 122 prior to transforming the positional and image embeddings 308 into the video representation. The combination of visual and positional information allows the system to capture both the content and temporal structure of the video clips in outputting the learned representation 214.

The transformer based video encoder 302 receives the combined positional and image embeddings. In some aspects, the transformer based video encoder 302 consists of four transformer layers with eight multi-heads. This architecture allows the encoder to process complex temporal relationships between different parts of the video sequence. The transformer based video encoder 302 processes these inputs and generates representations that are mapped into a feature space 212. The feature space 212 includes different clusters corresponding to various types of video sequences or assembly qualities.

A multi-layer perceptron head 310 (referred to herein as “MLP head 310”) processes the output from the transformer based video encoder 302. The system 300 produces a learned representation 214 as output. The learned representation 214 captures the characteristics of the processed video sequences and is usable for assessing the quality of multi-shot video assemblies. The learned representation 214 encodes information about the coherence, flow, and overall quality of the video assembly.

A contrastive pre-training manager 208 is included in the system 300. The contrastive pre-training manager 208 processes three types of sequences: a reference sequence 312, a positive sequence 314, and a negative sequence 316. In some implementations, the contrastive pre-training manager 208 uses InfoNCE loss for training the transformer based video encoder 302. The contrastive learning approach helps the machine learning model 116 to learn to distinguish between coherent and incoherent video assemblies.

The feature space 212 includes different clusters of learned representations, which are depicted as filled circles, empty circles, and patterned circles. These clusters correspond to different types of video sequences or assembly qualities. This clustering in the feature space allows the system to group similar video assemblies and distinguish between different levels of quality or coherence.

In some cases, the system 300 is implemented as part of the content processing system 104 within the computing device 102. The learned representation 214 generated by the system 300 are usable by the machine learning model 116 to produce the quality score 130 for the assembled video 128. This integration allows for seamless assessment of video assembly quality within the broader content processing workflow.

The contrastive pre-training manager 208 generates positive training samples as examples of the positive sequence 314 using various techniques to modify one or more original parts of multi-shot video clips while maintaining overall coherence. These techniques include frame level modifications, scene level modifications, shot or frame reordering, and temporal augmentations, to name a few.

For example, the contrastive pre-training manager 208 applies frame level augmentations to one or more frames of the original parts of the multi-shot video clips. These augmentations include adjustments to brightness, contrast, or geometric transformations of individual frames. By applying these modifications, the system creates positive examples that maintain portions of original content and structure of the original sequence while introducing minor variations.

Regarding scene level modifications, the contrastive pre-training manager 208 applies scene level modifications to one or more shots of the original parts of the multi-shot video clips. These modifications involve altering the color grading, applying filters, or adjusting the composition of complete scenes. This approach allows the system to generate positive examples that preserve the overall narrative structure while introducing variations at a higher level than individual frame modifications.

As examples of shot or frame reordering techniques, the contrastive pre-training manager 208 reorders at least two shots or frames of the original parts of the multi-shot video clips. This reordering is performed in a way that maintains the overall coherence of the sequence while introducing variations in the temporal structure. By creating these positive examples, the system learns to recognize that specific rearrangements of shots or frames result in coherent video assemblies.

In at least one example, temporal augmentations are applied by the contrastive pre-training manager 208 to one or more of the original parts of the multi-shot video clips. These augmentations include speeding up or slowing down specific segments, introducing brief pauses, or applying time-warping effects. By manipulating the temporal aspects of the video, the system generates positive examples that maintain the overall content and structure while introducing variations in pacing and timing.

These techniques allow the contrastive pre-training manager 208 to generate a diverse set of positive training samples that maintain coherence with the reference sequence 312 while introducing controlled variations. This approach enables the transformer based video encoder 302 to learn robust representations that capture the qualities of coherent video assemblies across a range of minor modifications and variations.

The contrastive pre-training manager 208 also generates negative training samples as examples of the negative sequence 316. For example, the contrastive pre-training manager 208 utilizes the vision encoders 304-1, 304-2, through 306-n to output respective embeddings extracted from each of the multi-shot video clips. The embeddings capture the visual and semantic content of the video clips in a high-dimensional space.

The system then performs a cosine similarity comparison between the embeddings of different video clips. This comparison allows the contrastive pre-training manager 208 to identify dissimilar video clips for each of the multi-shot video clips in the reference sequence 312. Based on this similarity analysis, the contrastive pre-training manager 208 replaces a subset of the original parts of the multi-shot video clips with the identified dissimilar clips.

By replacing coherent parts of the original sequence with dissimilar content, the contrastive pre-training manager 208 creates negative examples that significantly disrupt the coherence and semantic flow of the reference sequence 312. These negative samples provide clear examples of poorly assembled multi-shot videos, which enable the contrastive learning process. The transformer based video encoder 302 learns to distinguish between these incoherent assemblies and the coherent positive examples, enhancing an ability to assess video assembly quality effectively.

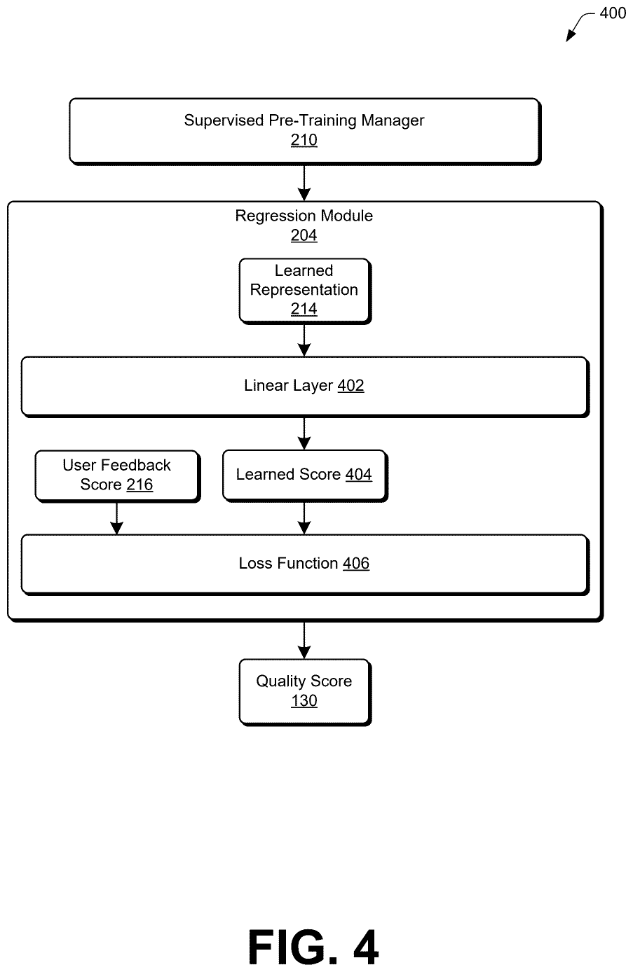

FIG. 4 illustrates a block diagram of a supervised training system 400 for training a regression model of the learning system 200. The supervised training system 400 is an example of at least part of the content processing system 104 depicted in FIG. 1.

The system 400 includes the supervised pre-training manager 210 that provides input to the regression module 204. Within the regression module 204, the learned representation 214 is processed through a linear layer 402 to generate a learned score 404. The system 400 also includes the user feedback score 216 that, along with the learned score 404, serves as input to a loss function 406.

In some aspects, the supervised pre-training manager 210 oversees the fine-tuning process of the machine learning model 116 using human-annotated data. The supervised pre-training manager 210 provides the learned representation 214 to the regression module 204 for further processing. This fine-tuning process allows the machine learning model 116 to align predictions with human judgments of video quality.

The regression module 204 utilizes the linear layer 402 to transform the learned representation 214 into a format suitable for comparison with the user feedback score 216. In some cases, the linear layer 402 applies a set of learnable weights to the input features, projecting them into a space that aligns with human judgments of video quality. This transformation enables the system to generate scores that are comparable to user-provided ratings.

The learned score 404 generated by the linear layer 402 represents a prediction of the video assembly quality. This score is compared to the user feedback score 216 using the loss function 406. In some implementations, the loss function 406 computes the difference between the predicted quality (learned score 404) and the actual quality (user feedback score 216) to guide the training process. This comparison allows the system to adjust parameters and improve predictions over time.

The regression module 204 outputs the quality score 130. In some cases, the system 400 uses binary cross-entropy loss for the regression training phase. The binary cross-entropy loss is particularly suitable for this task as the quality assessment is frameable as a binary classification problem (e.g., high quality versus low quality) with continuous probability outputs. This loss function helps the model learn to distinguish between high and low quality video assemblies while providing a nuanced score.

The quality score 130 generated by this process provides an objective assessment of the coherence and overall quality of the assembled video 128. This score is usable to guide users in creating more engaging and coherent multi-shot video sequences. By providing a quantitative measure of video quality, the system enables users to iteratively improve their video assemblies and achieve higher levels of coherence and engagement.

FIG. 5 illustrates a process 500 for training a machine learning model to assess multi-shot video sequences. In some embodiments, the process 500 describes operations that train the machine learning model 116 to produce the assembled video 128 based on the input 118, and to output the quality score 130 as an objective metric of assembly quality of the assembled video 128.

The process 500 begins at a step 502, where a plurality of multi-shot video clips are obtained. Multiple examples of the reference sequence 312 are received at a training input to the video encoder module 202 to be used as guides for generating training examples of multi-shot video sequences used to train the machine learning model 116. The examples of reference sequence 312 are storable within the data storage 108 of the computing device 102.

At a step 504, the process 500 generates positive training samples by modifying original parts of the multi-shot video clips. In aspects, a frame level augmentation is applied to at least one frame or scene of the reference sequence 312 to generate at least one corresponding example of the positive sequence 314. Frame level augmentations, for instance, include adjustments to brightness, contrast, or geometric transformations of individual or groups of frames from the reference sequence 312. The positive sequence 314 is configured to maintain coherence with the reference sequence 312, while introducing minor variations.

The process 500 then proceeds to a step 506, where negative training samples are produced by replacing the original parts with dissimilar video clips that are unrelated to the original parts. In some cases, the contrastive pre-training manager 208 performs a cosine similarity between the original parts of the reference sequence 312 and another (e.g., unrelated) example of the reference sequence 312 to identify dissimilar clips for construction of the negative sequence 316. This approach ensures that the negative sequence 316 significantly disrupts the coherences of the original parts of the reference sequence 312 and the positive training samples.

At a step 508, a transformer based video encoder is trained using contrastive learning based on the positive training samples and the negative training samples. The contrastive learning approach, for instance, is managed by the contrastive pre-training manager 208 to help the video encoder module 202 and the transformer based video encoder 302 to learn to distinguish between coherent and incoherent video assemblies.

The process 500 continues to a step 510, where user feedback quality scores for each of the multi-shot video clips are received. The user feedback scores 216, for instance, are collected for a subset of the multiple examples of the reference sequence 312 received at the step 502. The user feedback scores 216 are obtainable in various ways, including, for instance, through the user interface 110 displayed on the display device 112 of the computing device 102. The user interface 110 enables a user of the computing device to view the reference sequence 312 and after viewing, providing a rating (e.g., a numeric score) indicating whether the user identifies the reference sequence 312 as high quality, low quality, and so forth. The multi-shot video clips are presented through the user interface 110, and the user inputs 124 are received at the user interface 110 indicative of user ratings for each of the multi-shot video clips.

Finally, at a step 512, the process 500 trains a regression layer of the machine learning model using the user feedback quality scores to output a learned quality score for each of the multi-shot video clips. The regression module 204, for instance, passes the learned representation 214 generated for the reference sequence 312 to the linear layer 402, which outputs the learned score 404. The loss function 406 aligns the learned score 404 predicted by the machine learning model 116 with one or more indications of the user feedback score 216 (e.g., a subjective human judgments of video assembly quality) to arrive at the quality score 130.

By following this process 500, the machine learning model 116 learns to assess the coherence and quality of multi-shot video sequences, combining unsupervised contrastive learning with supervised fine-tuning based on user feedback.

FIG. 6 illustrates a flowchart of a process 600 for assessing the quality of multi-shot video assemblies. In some embodiments, the process 600 describes operations of the machine learning model 116 for producing the assembled video 128 based on the input 118, and to output the quality score 130 as an objective metric of assembly quality.

The process 600 begins at a step 602, where a plurality of single-shot video clips are received. The single-shot video clips 122, for instance, are received as the input 118 and the machine learning model 116 obtains the single-shot video clips 122 from the data storage 108 when accessed by the content processing system 104. The single-shot video clips 122 are generatable by segmenting longer videos using shot boundary detection techniques. For example, one or more multi-shot videos are segmented into a plurality of individual, single-shot video clips representing different scenes using TransNetV2, which is a deep learning-based shot boundary detection model. TransNetV2 utilizes convolutional neural networks to analyze consecutive video frames and identify significant visual changes that indicate transitions between shots (e.g., transitions between scenes). In the step 602, TransNetV2 is usable to process an input video by examining pairs of adjacent frames and outputting probabilities of shot boundaries occurring at each frame. A shot boundary detection model like TransNetV2 uses the probabilities to determine the start and end points of individual shots, effectively splitting the longer video into the plurality of single-shot video clips 122 for further processing.

At a step 604, the process 600 generates embeddings based on each single-shot video clip using one or more vision encoders. For example, the vision encoders 304 of the video encoder module 202 are configured to process visual content of each of the single-shot video clips 122 to extract relevant features and create compact representations, such as the positional and image embeddings 308, which are fed as inputs to the transformer based video encoder 302. In some cases, the vision encoders 304 include contrastive language-image pre-training vision encoders, such as a CLIP ViT/B-32 model, which is pre-trained to produce respective embeddings from each of the single-shot video clips 122. The vision encoders 304 are configurable to uniformly sample a predetermined number of frames, such as ten frames, or a predetermined duration (e.g., two to ten seconds), from each of the single-shot video clips 122 for encoding. The positional and image embeddings 308 are configured to capture visual features and positional (e.g., temporal) information about the frames within each of the single-shot video clips 122. When combined, the positional and image embeddings 308 create a comprehensive representation of each of the single-shot video clips 122, preserving both visual content and sequential order information.

The process 600 then proceeds to a step 606, where the embeddings are transformed into a video representation using a transformer based video encoder. The transformer based video encoder 302, for instance, processes the image and positional embeddings 308 through multiple transformer layers with multi-head attention features that analyze relationships between different parts of a video sequence, capturing temporal dependencies and contextual information across the single-shot video clips 122. The output of the transformer layers are processed through the MLP head 310, which is configured to perform additional non-linear transformations. The output from the MLP head 310 is mapped into the feature space 212, where different clusters of learned representations correspond to various types of video sequences or assembly qualities. The learned representation 214 is derived by the video encoder module 202 to produce a compact, high-dimensional vector that encapsulates the characteristics of a multi-shot video sequence.

At a step 608, the process 600 determines a learned quality score of a multi-shot video sequence assembled from the single-shot video clips by processing the video representation through a regression layer. The learned representation 214, for instance, serves as input to the regression module 204, which applies a linear layer 402 to transform the representation into a learned score 404. The learned score 404 is then compared to the user feedback score 216 using the loss function 406, such as binary cross-entropy loss function. The regression module 204 is trainable using the user feedback scores 216 collected for a subset of multi-shot videos to align the learned score 404 with human expectations for video assembly quality. During training, positive samples are generated by applying frame-level augmentations or scene-level modifications to original parts of the multi-shot video clips, while maintaining overall coherence. The supervised pre-training manager 210 oversees the training process, iteratively adjusting parameters of the regression module 204 to reduce (e.g., minimize) a difference between the learned score 404 and the user feedback score 216. The approach followed in the step 608 enables the content processing system 104 to generate the quality score 130 for the assembled video 128 that reflects user preferences, generally, for multi-shot video coherence and semantic flow.

The process 600 concludes at a step 610, where the learned quality score is output as a measure of assembly quality for the multi-shot video sequence. For example, the quality score 130 represents an objective quality metric for the assembled video 128 derived from the video representation 214. The quality score 130 is presentable through the user interface 110 on the display device 112 of the computing device 102. Outputting the quality score 130 for display give a user of the computing device 102 a measured and objective assessment of how well the single-shot video clips 122 are assembled into the assembled video 128. A higher quality score, for example, indicates a greater level of coherence and semantic flow between individual scenes of the assembled video 128.

In variations, the process 600 includes additional steps to optimize the multi-shot video sequence assembly. Responsive to receiving the plurality of single-shot video clips 122 at step 602, the process 600, for instance, causes the machine learning model 116 to assemble a plurality of possible multi-shot videos from the single-shot video clips 122. This assembly process can involve various combinations and arrangements of the received single-shot video clips 122. Following the generation of these possible multi-shot videos, the machine learning model 116 evaluates each of the possible multi-shot videos to calculate respective learned quality scores. This evaluation utilizes the steps 604 through 608, where embeddings are generated, transformed into video representations, and processed through the regression model for each possible multi-shot video. The machine learning model 116 then selects the multi-shot video sequence with an acceptable learned quality score, e.g., a highest learned quality score among each of the possible multi-shot videos. This selection helps ensure that the output multi-shot video sequence at step 610 represents a more coherent or high-quality assembly of the input single-shot video clips, as determined by the machine learning model 116.

In some cases, the multi-shot video sequence 126 is assembled from the single-shot video clips 122 based on the quality score 130. Responsive to the quality score 130 satisfying a quality threshold, the machine learning model 116 constructs the assembled video 128 to represent the multi-shot video sequence 126 as a series including a plurality of the single-shot video clips 122. Responsive to the quality score 130 not satisfying the quality threshold, the machine learning model 116, as described above, improves the multi-shot video sequence 126 by regenerating the multi-shot video sequence 126, automatically or based in part on commands interpreted from the user input 124, possibly multiple times to improve the quality score 130 towards satisfying the quality threshold.

FIG. 7 shows a flow diagram depicting an algorithm as a step-by-step process 700, which is performable by a processing device when executing a training module for training a learning system to implement learning based coherency assessment of clip assemblies for multi-shot videos. In some embodiments, the process 700 describes operations of the training module 202 for configuring the machine learning model 116 to produce the assembled video 128 based on the input 118, and to output the quality score 130 as objective metric of assembly quality. The process 700 provides one or more examples of generating training data, use of the training data to train a machine learning model, such as the machine learning model 116, and use of the trained machine learning model to perform a task, including learning based coherency assessment of clip assemblies for multi-shot videos.

To begin in this example, a machine learning system collects training data (block 702) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 704) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 706). Initialization of the machine learning model includes selecting a model architecture (block 708) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 710). The loss function is utilized to measure a difference between an output of the machine learning model (i.e., predictions) and target values (e.g., as expressed by the training data) to be used to train the machine learning model. Additionally, an optimization algorithm is selected (712) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 714) examples of which includes initializing weights and biases of nodes to improve efficiency in training and computational resources consumption as part of training. Hyperparameters are also set (block 716) that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 718) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 720), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 720), the procedure 700 continues training of the machine learning model using the training data (block 718) in this example.

If the stopping criterion is met (“yes” from decision block 720), the trained machine learning model is then utilized to generate an output based on subsequent data (block 722). The trained machine learning model, for instance, is trained to perform a task as described above and therefore once trained is configured to perform that task based on subsequent data received as an input and processed by the machine learning model.

### Example System and Device for Clip Assembly Coherency Assessments

FIG. 8 illustrates an example system including various components of an example device usable as any type of computing device as described and/or utilized with reference to FIGS. 1-7 to implement examples of the techniques described herein. FIG. 8 illustrates an example system 800 generally, which includes an example computing device 802 that is representative of one or more computing systems and/or devices that implement the various techniques described herein. This is illustrated through inclusion of the machine learning model 116. The computing device 802 is configurable, for instance, as a server of a service provider, as a device associated with a client (e.g., a client device), as an on-chip system, and/or as any other suitable computing device or computing system.

The example computing device 802 as illustrated includes a processing system 804, one or more computer-readable media 806, and one or more I/O interface 808 that are communicatively coupled, one to another. Although not shown, the computing device 802 further includes a system bus or other data and command transfer system that couples the various components, one to another. In one or more examples, a system bus includes a single bus structure, or combination, of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 804 is representative of functionality to perform one or more operations using hardware. Accordingly, the processing system 804 is illustrated as including the hardware elements 810, which are configurable as processors, functional blocks, and so forth. This includes implementation in hardware as an application specific integrated circuit or other logic device formed using one or more semiconductors. The hardware elements 810 are not limited by the materials that form the hardware elements 810, or the processing mechanisms employed therein. For example, processors are configurable as semiconductor(s) and/or transistors, e.g., electronic integrated circuits (ICs). In such a context, processor-executable instructions are electronically executable instructions.

The computer-readable media 806 is storage media illustrated as including memory/storage 812. The memory/storage 812 represents memory/storage capacity associated with one or more computer-readable media. The memory/storage 812 is configured as a memory component, for example, which is configured to store the digital content 106. The memory/storage 812 includes volatile media (such as random access memory (RAM)) and/or nonvolatile media, such as read-only memory (ROM), Flash memory, optical disks, magnetic disks, and so forth. The memory/storage 812 includes fixed media (e.g., RAM, ROM, a fixed hard drive, and so on) as well as removable media, e.g., Flash memory, a removable hard drive, an optical disc, and so forth. The computer-readable media 806 is configurable in a variety of other ways as further described below.

Input/output interface(s) 808 are representative of functionality to allow a user to enter commands and information to computing device 802, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 802 is configurable in a variety of ways to support user interaction, as described herein.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms and for a variety of processors.

An implementation of the described modules and techniques is stored on or transmitted across some form of computer-readable media. The computer-readable media includes a variety of media that is accessed by the computing device 802. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 802, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of signal characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 810 and computer-readable media 806 are representative of modules, programmable device logic and/or fixed device logic implemented in a hardware form that are employed in some examples to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously. For example, the hardware elements 810 include a processing device coupled to the memory component implemented by the memory/storage 812 to perform operations of the machine learning model 116. The operations, when executed, cause the processing device implemented by the hardware elements 810 to generate the digital content 106 to be stored in the memory/storage 812, which is an example of the data storage 108.

Combinations of the foregoing are also employed to implement various techniques described herein. Accordingly, software, hardware, or executable modules are implemented as one or more instructions and/or logic embodied on some form of computer-readable storage media and/or by one or more hardware elements 810. The computing device 802 is configured to implement particular instructions and/or functions corresponding to the software and/or hardware modules. Accordingly, implementation of a module that is executable by the computing device 802 as software is achieved at least partially in hardware, e.g., through use of computer-readable storage media and/or hardware elements 810 of the processing system 804. The instructions and/or functions are executable/operable by one or more articles of manufacture (e.g., at least one computing device 802 and/or processing systems 804) to implement techniques, modules, and examples described herein.

The techniques described herein are supported by various configurations of the computing device 802 and are not limited to the specific examples of the techniques described herein. This functionality is also implementable or partially implementable through use of a distributed system, such as over a “cloud” 814 via a platform 816 as described below.

The cloud 814 includes and/or is representative of a platform 816 for resources 818. The platform 816 abstracts underlying functionality of hardware (e.g., servers) and software resources of the cloud 814. The resources 818 include applications and/or data utilized while computer processing is executed on servers that are remote from the computing device 802. In at least one example, the resources 818 include services provided over the Internet and/or through a subscriber network, such as a cellular or Wi-Fi network.

The platform 816 abstracts resources and functions to connect the computing device 802 with other computing devices. The platform 816 also serves to abstract scaling of resources to provide a corresponding level of scale to encountered demand for the resources 818 that are implemented via the platform 816. Accordingly, in an interconnected device example, implementation of functionality described herein is distributable throughout the system 800. The functionality is implementable in part on the computing device 802 as well as via the platform 816 that abstracts the functionality of the cloud 814

Although the techniques have been described in language specific to structural features and/or methodological acts, it is to be understood that the techniques defined in the appended claims are not limited to the specific features or acts described. Rather, the specific features and acts are disclosed as example forms of implementing the claims.

1. A method comprising:
receiving, by a processing device, a plurality of single-shot video clips;
generating, by the processing device, embeddings of each of the single-shot video clips using a machine learning model;
transforming the embeddings into a video representation using the machine learning model;
determining, by the processing device, a learned quality score of a multi-shot video sequence assembled from the single-shot video clips by processing the video representation through a regression layer of the machine learning model; and
outputting, by the processing device, the learned quality score as a measure of assembly quality for the multi-shot video sequence.

2. The method of claim 1, wherein the generating includes using a vision encoder of the machine learning model trained to produce respective embeddings from each of the single-shot video clips.

3. The method of claim 2, wherein the vision encoder includes a contrastive language-image pre-training vision encoder, and the respective embeddings include at least one of image embeddings and positional embeddings.

4. The method of claim 1, wherein the transforming includes using a transformer based video encoder of the machine learning model to transform the embeddings into temporal and spatial relationships among the single-shot video clips captured by the video representation.

5. The method of claim 1, further comprising:
combining, by the processing device, image type embeddings and positional type embeddings of each of the single-shot video clips prior to transforming the embeddings into the video representation.

6. The method of claim 1, further comprising:
assembling, by the processing device, the multi-shot video from the single-shot video clips; and
outputting, by the processing device, the multi-shot video sequence for playback at a user interface when the learned quality score satisfies a quality threshold.

7. The method of claim 1, wherein each of the single-shot video clips depicts a single cohesive scene that is less than one minute in duration.

8. A system comprising:
a memory component; and
one or more processing devices coupled to the memory component to perform operations including:
obtaining a plurality of multi-shot video clips;
generating positive training samples by modifying parts of the multi-shot video clips;
producing negative training samples by replacing the parts with dissimilar video clips that are unrelated to the parts; and
training a machine learning model to output a learned quality score for each of the multi-shot video clips using contrastive learning to train a transformer based video encoder based on the positive training samples and the negative training samples.

9. The system of claim 8, the training includes:
receiving user feedback quality scores for each of the multi-shot video clips; and
using the user feedback quality scores to train a regression layer of the machine learning model to output the learned quality score for each of the multi-shot video clips.

10. The system of claim 8, wherein the generating includes:
applying frame level modifications to one or more frames of the parts of the multi-shot video clips.

11. The system of claim 8, wherein the generating includes:
applying scene level modifications to one or more shots of the parts of the multi-shot video clips.

12. The system of claim 8, wherein the generating includes:
reordering at least two shots or frames of the parts of the multi-shot video clips.

13. The system of claim 8, wherein the generating includes:
applying temporal augmentations to one or more of the parts of the multi-shot video clips.

14. The system of claim 8, wherein the generating includes using a contrastive language-image pre-training vision encoder of the machine learning model trained to output respective embeddings extracted from each of the multi-shot video clips.

15. The system of claim 8, wherein the producing includes:
outputting, from a contrastive language-image pre-training vision encoder of the machine learning model, respective embeddings extracted from each of the multi-shot video clips; and
responsive to identifying the dissimilar video clips for each of the multi-shot video clips based on cosine similarity of the respective embeddings extracted from that multi-shot video clip, replacing a subset of the parts of the multi-shot video clips with the dissimilar clips.

16. The system of claim 8, the operations further comprising:
applying a multi-layer perceptron head of the machine learning model to an output of the transformer based video encoder prior to training the transformer based video encoder.

17. The system of claim 8, the operations further comprising:
presenting the multi-shot video clips through a user interface; and
receiving user inputs at the user interface indicative of user ratings for each of the multi-shot video clips.

18. A non-transitory computer readable storage medium storing executable instructions, which when executed by one or more processing devices, cause the one or more processing devices to perform operations comprising:
receiving a plurality of single-shot video clips;
processing the single-shot video clips through a transformer based video encoder to generate a video representation;
generating a learned quality score of a multi-shot video sequence assembled from the single-shot video clips by inputting the video representation into a regression model; and
outputting the multi-shot video sequence and the learned quality score.

19. The non-transitory computer readable storage medium of claim 18, the generating including:
assembling a plurality of possible multi-shot videos from the single-shot video clips;
evaluating each of the possible multi-shot videos to calculate a respective learned quality scores for that possible multi-shot video; and
selecting the multi-shot video sequence from the possible multi-shot videos based on the learned quality score being a highest learned quality score among each of the possible multi-shot videos.

20. The non-transitory computer readable storage medium of claim 18, wherein the outputting includes:
presenting the multi-shot video sequence for playback via a user interface when the learned quality score satisfies a quality threshold; and
generating another learned quality score of another multi-shot video sequence assembled from the single-shot video clips when the learned quality score does not satisfy the quality threshold.
